(19) United States
(12) Patent Application Publication
(10) Pub. No.: US 2006/0010263 A1
(43) Pub. Date: Jan. 12, 2006

(54) Direct memory access (DMA) devices, data transfer systems including DMA devices and methods of performing data transfer operations using the same

(76) Inventor: Si-Young Kim, Seoul (KR)

Correspondence Address: MYERS BIGEL SIBLEY & SAJOVEC, PO BOX 37428, RALEIGH, NC, 27627, US

(21) Appl. No.: 11/175,498

(22) Filed: Jul. 6, 2005

(30) Foreign Application Priority Data
Jul. 10, 2004 (KR) 10-2004-0053745

(51) Int. Cl. G06F 13/28

(52) U.S. Cl. 710/22

(57) ABSTRACT

Data transfer systems are provided. The data transfer systems include a bridge direct memory access (DMA) device. A first memory is electrically coupled to the bridge DMA device and a second memory is electrically coupled to the bridge DMA device. The bridge DMA device is configured to control data transfer operations between the first memory and the second memory. Direct memory access devices and methods of performing data transfer operations are also provided.

### CLAIM OF PRIORITY

This application is related to and claims priority from Korean Patent Application No. 2004-53745 filed on Jul. 10, 2004, the disclosure of which is hereby incorporated herein by reference as if set forth in its entirety.

### FIELD OF THE INVENTION

The present invention relates to integrated circuit devices and methods of operating the same and, more particularly, direct memory access (DMA) devices and methods of operating the same.

### BACKGROUND OF THE INVENTION

In conventional data transfer systems, decoding or encoding of video data or audio data is typically performed by dividing the data into frames including data sets of predetermined quantities. Each of these frames is then typically processed individually. These conventional data transfer systems may include, for example, a Microcontroller Unit (MCU) for managing and controlling the system and a Digital Signal Processor (DSP) that may be used for different calculations, for example, encoding and decoding. Furthermore, the data transfer system may further include a dual port memory between the MCU and the DSP to facilitate transfer of the data between the MCU and the DSP.

Referring now to FIG. 1, a block diagram conventional data transfer systems between an MCU and a DSP will be discussed. As illustrated in FIG. 1, a data transfer system 100 includes an MCU 110, a first memory (MEM) 130, a dual port (DP) memory 150, a first direct memory access (DMA) device 160, a second direct memory access (DMA) device 170, a second memory 140 and a DSP 120.

As further illustrated in FIG. 1, the MCU 110 is coupled to the first memory 130 via a bus 101, and the DSP 120 is coupled to the second memory 140. In order to transfer data between the MCU 110 and the DSP 120, the data transfer system 100 includes a dual port memory 150 between the MCU 110 and the DSP 120. In particular, the data transfer system 100 transmits and receives data through the first direct memory access (DMA) device 160 and the second direct memory access (DMA) device 170 so as to transfer data between the dual port memory 150 and the first memory 130, or to transfer data between the dual port memory 150 and the second memory 140. Thus, the following data transfer sequences may be followed in a conventional data transfer system 100: the first memory 130 to the first DMA device 160 to the dual port memory 150 to the second DMA device 170 to the second memory 140.

In other words, the first DMA device 160 controls data transfer operations between the first memory 130 and the dual port memory 150, and the second DMA device 170 controls data transfer operations between the second memory 140 and the dual port memory 150. Accordingly, in conventional data transfer systems, for example, data transfer system 100, the data may pass through many modules and may include many bus operations. Furthermore, the size of the dual port memory 150, which is located between the first DMA 160 and the second DMA 170, may be increased so as to allow it to store the different data transfer protocols for the MCU 110 and the DSP 120.

### SUMMARY OF THE INVENTION

Some embodiments of the present invention provide data transfer systems. The data transfer systems include a bridge direct memory access (DMA) device. A first memory is electrically coupled to the bridge DMA device and a second memory is electrically coupled to the bridge DMA device. The bridge DMA device is configured to control data transfer operations between the first memory and the second memory.

In further embodiments of the present invention, the bridge DMA device may include a first register block, a second register block and a controller. The first register block may be configured to store first transfer information for transferring data stored in the first memory to the second memory. The second register block may be configured to store second transfer information for transferring data stored in the second memory to the first memory. The controller may be electrically coupled to the first and second register blocks and may be configured to control the data transfer operations between the first memory and the second memory responsive to the first transfer information and/or the second transfer information.

In still further embodiments of the present invention, the bridge DMA device may further include a third memory configured to store data read from the first memory and/or the second memory based on the first and/or second transfer information responsive to a first control signal of the controller. The bridge DMA device may further include an address generator configured to generate a first address of the first memory and/or a second address of the second memory to transfer the data stored in the third memory responsive to a second control signal of the controller.

In some embodiments of the present invention, the first register block may include a first address register having a source address of the first memory, a second address register having a destination address of the second memory and a first count register having a data quantity to be transferred to the second memory from the first memory. Similarly, the second register block may include a third address register having a source address of the second memory, a fourth address register having a destination address of the first memory and a second count register having a data quantity to be transferred to the first memory from the second memory.

In further embodiments of the present invention, the first memory may be electrically coupled to a first processor and the second memory may be electrically coupled to a second processor. The first processor may be configured to generate the source address of the first memory, the destination address of the first memory and the data quantity to be transferred to the second memory from the first memory. The second processor may be configured to generate the source address of the second memory, the destination address of the second memory and the data quantity to be transferred to the first memory from the second memory.

In still further embodiments of the present invention, the controller may include a first start register configured to receive a first start command instructing an execution point of transferring data from the first memory to the second memory. The controller may further include a second start register configured to receive a second start command instructing an execution point of transferring data from the second memory to the first memory.

In some embodiments of the present invention, the controller may further include an arbiter configured to delay an execution point of the second start command for a predetermined period of time so as to avoid overlapping between a process transferring data from the first memory to the second memory and a process transferring data from the second memory to the first memory.

While the present invention is described above primarily with reference to data transfer systems, direct memory access (DMA devices) and methods of performing data transfer operations are also provided herein.

### BRIEF DESCRIPTION OF THE DRAWINGS

FIG. 1 is a block diagram illustrating conventional data transfer systems for the transfer of data between a Microcontroller Unit (MCU) and a Digital Signal Processor (DSP).

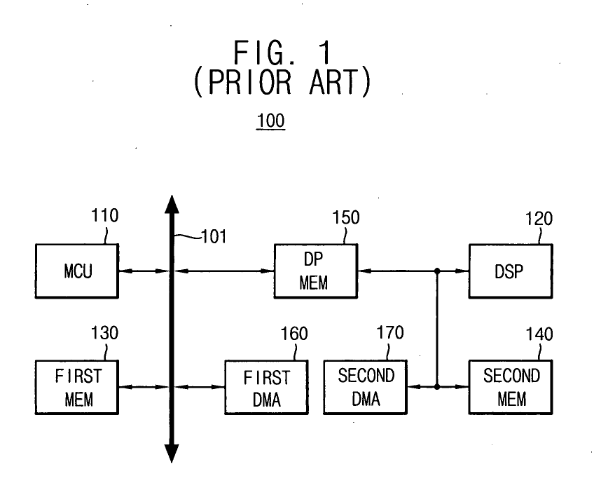

FIG. 2 is a block diagram illustrating data transfer systems according to some embodiments of the present.

FIG. 3 is a block diagram illustrating bridge Direct Memory Access (DMA) devices according to some embodiments of the present invention.

FIG. 4 is a timing diagram illustrating operations of DMA devices according to some embodiments of the present invention.

FIG. 5 is a timing diagram illustrating operations of DMA devices according to further embodiments of the present invention.

### DETAILED DESCRIPTION OF EMBODIMENTS OF THE PRESENT INVENTION

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity. It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. As used herein, the term “and/or” includes any and all combinations of one or more of the associated listed items. Like numbers refer to like elements throughout.

It will be understood that although the terms first and second are used herein to describe elements and should not be limited by these terms. These terms are only used to distinguish one element from another. Thus, a first element discussed below could be termed a second region, layer or section, and similarly, a second element may be termed a first element without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

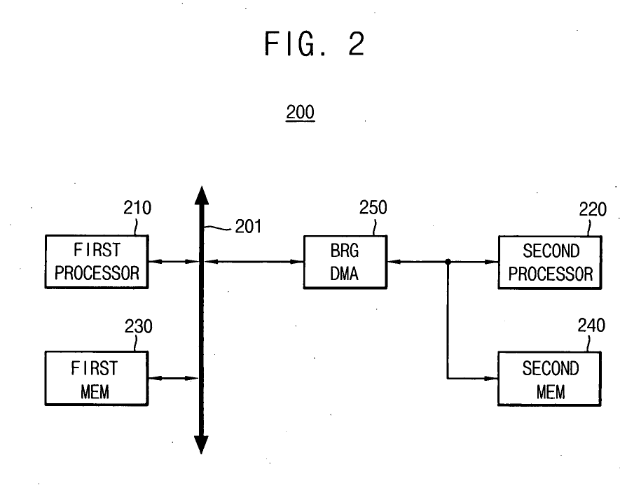

Referring now to FIG. 2, a block diagram illustrating a data transfer system for transferring data between a first memory coupled to a first processor (or processor circuit) and a second memory coupled to a second processor (or processor circuit) according to some embodiments of the present invention will be discussed. As illustrated in FIG. 2, the data transfer system 200 includes a first processor 210, a first memory 230, a bridge (BRG) direct memory access (DMA) device 250, a second memory 240 and a second processor 220.

The first processor 210 is coupled to the first memory 230 via a bus 201. The first memory 230 is configured to store data for operating a system. The second processor 220 is coupled to the second memory 240. The second memory 240 is configured to store data used for operations of the second processor 220 and/or result data after performing operations. As illustrated in FIG. 2, in some embodiments of the present invention, the first memory 230 and the second memory 240 are configured to be indirectly coupled to each other via the bridge DMA device 250.

As discussed in the background of the invention, conventional data transfer systems typically include a first DMA coupled to a first memory, a second DMA coupled to a second memory and a dual port memory for coupling the first DMA to the second DMA. In contrast, data transfer system according to some embodiments of the present invention include the first memory 230 that is coupled to the second memory 240 through the bridge DMA 250. Thus, a data transfer sequence according to some embodiments of the present invention may be: the first memory 230 to the bridge DMA 250 to the second memory 240.

In other words, data transfer systems according to some embodiments of the present invention only include two data transfer steps, in contrast to the four data transfer steps of conventional data transfer systems. Thus, data transfer speeds of data transfer systems according to some embodiments of the present invention may be increased.

In some embodiments of the present invention, the first processor 210 may be, for example, a central processing unit (CPU) or a microcontroller unit (MCU). The second processor 220 may be, for example, a digital signal processor (DSP). It will be understood that although the first processor 210 may be a CPU or an MCU, embodiments of the present invention are not limited to this configuration. Similarly, although the second processor 220 is described as a DSP, embodiments of the present invention are not limited to this configuration. The first processor 210 and the second processor 220 may be other processors or controllers that perform operations and controls known to those having skill in the art without departing from the scope of the present invention.

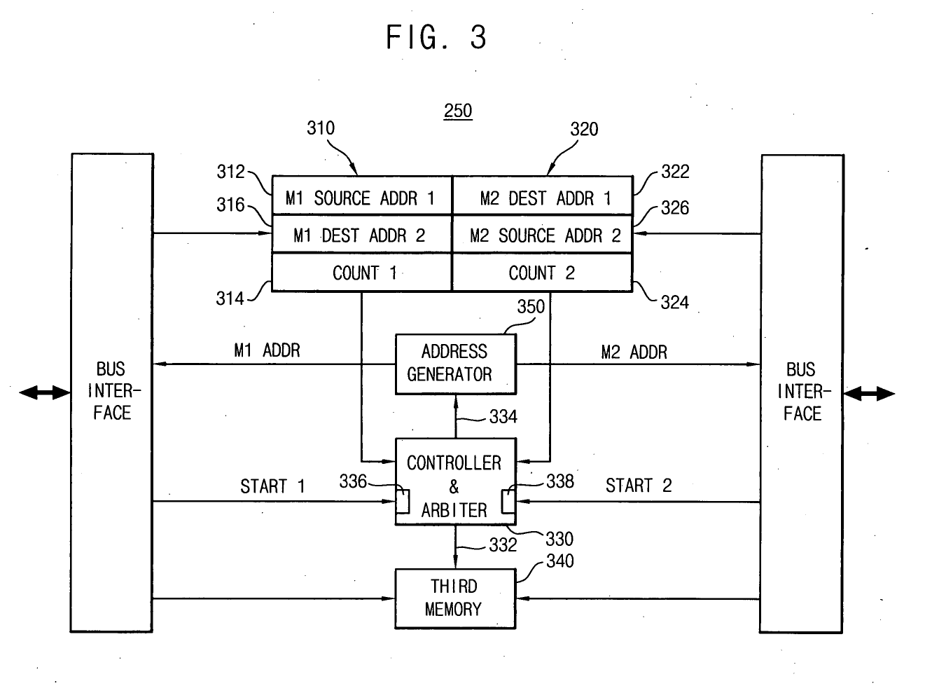

Referring now to FIG. 3, a block diagram illustrating a bridge DMA according to further embodiments of the present invention will be discussed. As illustrated in FIG. 3, in some embodiments of the present invention the bridge DMA 250 includes a first register block 310, a second register block 320, a controller 330, a third memory 340 and an address generator 350.

The first register block 310 is configured to store first transfer information used for transferring data stored in the first memory 230 to the second memory 240. The second register block 320 is configured to store second transfer information used for transferring data stored in the second memory 240 to the first memory 230. The controller 330 is configured to control data transfer operations between the first memory 230 and the second memory 240 based on transfer information received from the first register block 310 and the second register block 320. The third memory 340 is configured to store data read from the first memory 230 or the second memory 240 based on the first or the second transfer information in response to a first control signal 332. In some embodiments of the present invention, the third memory 340 may be implemented by, for example, a latch. The address generator 350 may be configured to generate an address of the first memory 230 or the second memory 240 so as to transfer data stored in the third memory 340 to the first memory 230 or the second memory 240 in response to a second control signal 334.

As further illustrated in FIG. 3, the first register block 310 includes a first address register 312, a second address register 316 and a first count register 314. The first address register 312 has a source address (M1 SOURCE ADDR 1) of the first memory 230, the first count register 314 has a data quantity COUNT 1 to be transferred to the second memory 240 from the first memory 230, the second address register 316 has a destination address (M1 DEST ADDR 2) corresponding to a location of the first memory 230 where the data of the second memory 240 is to be transferred.

The second register block 320 includes a third address register 322, a fourth address register 326 and a second count register 324. The third address register 322 has a destination address (M2 DEST ADDR 1) corresponding to a location of the second memory 240 where data of the first memory 230 are to be transferred. The fourth address register 326 has a source address (M2 SOURCE ADDR 2) of the second memory 240 data. The second count register 324 has a data quantity COUNT 2 to be transferred to the first memory 230 from the second memory 240.

In some embodiments of the present invention, the bridge DMA 250 is configured to transfer data stored in the first memory 230 to the second memory 240 using three kinds of transfer information stored in the first address register 312 (M1 SOURCE ADDR 1), the first count register 314 (COUNT 1) and the third address register 322 (M2 DEST ADDR 1). In other words, the bridge DMA 250 is configured to read data corresponding to a source address (M1 SOURCE ADDR 1) of the first memory 230, and then writes the data through the third memory 340 into a destination address (M2 DEST ADDR 1) of the second memory 240.

In some embodiments of the present invention, the bridge DMA 250 may be configured to transfer the data stored in the second memory 240 to the first memory 230 using three kinds of transfer information stored in the fourth address register 326 (M2 SOURCE ADDR 2), the second count register 324 (COUNT 2) and the second address register 316 (M1 DEST ADDR 2). In other words, the bridge DMA 250 reads data corresponding to a source address (M2 SOURCE ADDR 2) of the second memory 240, and then writes the data through the third memory 340 into a destination address (M1 DEST ADDR 2) of the first memory 230.

It will be understood that in some embodiments of the present invention, the bridge DMA 250 may be configured to transfer the data read from the first memory 230 to the second memory 240 without passing through the third memory 340. Similarly, the bridge DMA 250 may be configured to transfer the data read from the second memory 240 to the first memory 230 without passing through the third memory 340.

Referring to FIGS. 2 and 3, the first processor 210 generates a source address (M1 SOURCE ADDR 1) of the first memory 230, the data quantity COUNT 1 to be transferred and a destination address (M2 DEST ADDR 1) corresponding to a location of the second memory 240 where the data read from the first memory 230 is to be transferred. The second processor 220 generates a source address (M2 SOURCE ADDR 2) of the second memory 240, the data quantity COUNT 2 to be transferred and a destination address (M1 DEST ADDR 2) corresponding to a location of the first memory 230 where the data read from the second memory 240 is to be transferred.

In some embodiments of the present invention, the controller 330 may include, for example, a first start register 336 and a second start register 338 as illustrated in FIG. 3. The first start register 336 may receive a first start command, which instructs an execution point of a data transfer operation using transfer information of the first register block 310, from the first processor 210. The second start register 338 may receive a second start command, which instructs an execution point of a data transfer operation using transfer information of the second register block 320 from the second processor 220.

When the controller 330 receives the first start command START 1, the controller 330 transfers the data read from the first memory 230 to the second memory 240 based on the transfer information stored in the first address register 312 and the third address register 322. Similarly, when the controller 330 receives the second start command START 2, the controller 330 transfers the data read from the second memory 240 to the first memory 230 based on the transfer information stored in the fourth address register 326 and the second address register 316.

In some embodiments of the present invention, the controller 330 may further include an arbiter for delaying executions of the first start command START 1 and the second start command START 2. Although embodiments of the present invention are discussed herein as having the arbiter included in the controller 300, embodiments of the present invention are not limited to this configuration. For example, the arbiter may be separate from the controller 300 without departing from the scope of the present invention.

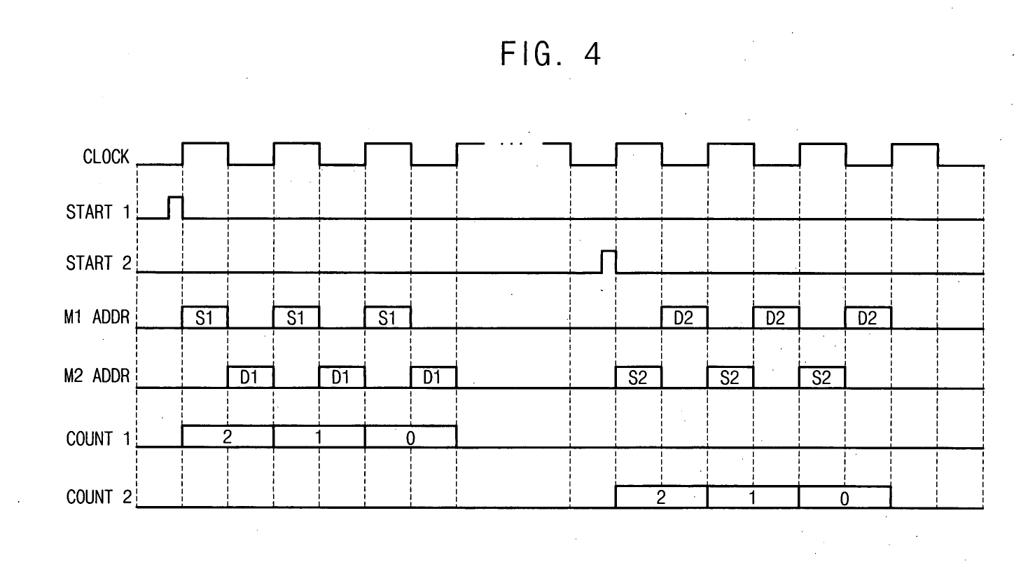

FIG. 4 is a timing diagram illustrating operations of a DMA device according to some embodiments of the present invention will be discussed. In particular, FIG. 4 is a timing diagram illustrating embodiments of the present invention where data is transferred from the first memory 230 to the second memory 240 and does not overlap with a process of transferring data from the second memory 240 to the first memory 230.

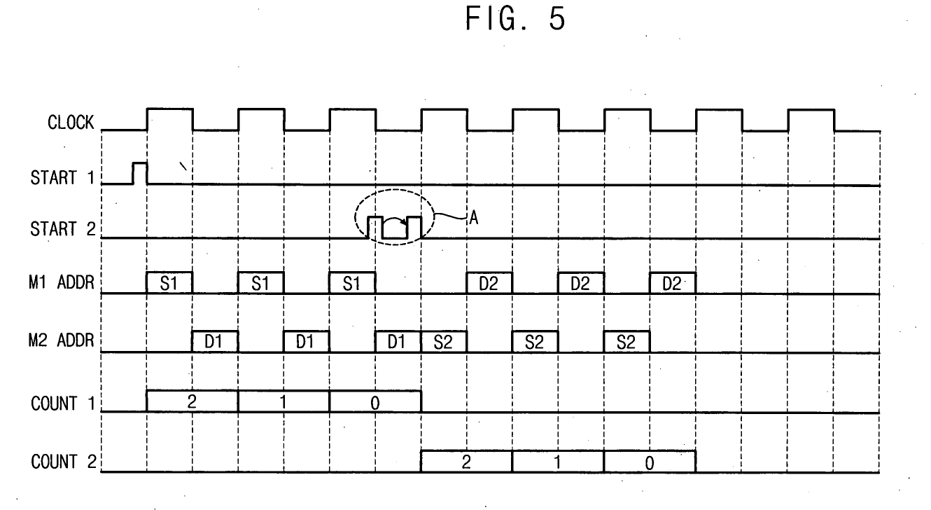

FIG. 5 is a timing diagram illustrating operations of a DMA device according to further embodiments of the present invention. In particular, FIG. 5 is a timing diagram illustrating embodiments of the present invention where data is transferred from the first memory 230 to the second memory 240 and overlaps with the process transferring data from the second memory 240 to the first memory 230.

Referring now to FIGS. 2 through 5, operations of the bridge DMA 250 according to some embodiments of the present invention will be discussed. The first processor 210 may generate a first start command START 1 to provide the first start command START 1 to the controller 330. After generating the first start command START 1, the first processor 210 provides a source address (M1 SOURCE ADDR 1), a count (COUNT 1) and a destination address (M2 DEST ADDR 1) into the first register block 310. The source address (M1 SOURCE ADDR 1) points to a location in the first memory 230 where data is stored. The count (COUNT 1) represents a quantity of data to be transferred to the second memory 240 from the first memory 230. The destination address (M2 DEST ADDR 1) points to a location where data is to be stored in the second memory 240.

As illustrated in the first portion of the timing diagram of FIG. 4, the first processor 210 provides a source address S1 of the first memory 230, a destination address D1 of the second memory 240 and a count (2) COUNT 1 of the data to be transferred to the second memory 240 into the controller 330 during a first clock cycle. Data may be read from the first memory 230 by as much as the quantity of the count value, and the read data is provided to the second memory 240 via the third memory 340.

As further illustrated in FIG. 4, the first processor 210 provides a source address S1 of the first memory 230, a destination address D1 of the second memory 240 and a count (1) COUNT 1 of the data to be transferred to the second memory 240 into the controller 330 during a second clock cycle.

Finally, the first processor 210 provides a source address S1 of the first memory 230, a destination address D1 of the second memory 240 and a count (0) COUNT 1 of the data to be transferred to the second memory 240 into the controller 330 during a third clock cycle. When the count value is equal to ‘0’, the data transfer operation is complete.

Furthermore, the second processor 220, for example, a DSP, may perform a particular operation using the data transferred from the first memory 230 to the second memory 240, and then the result data of the particular operation is transferred to the first memory 230, again.

After generating a second start command START 2, the second processor 220 provides a source address (M2 SOURCE ADDR 2), a count (COUNT 2) and a destination address (M1 DEST ADDR 2). The source address (M2 SOURCE ADDR 2) points to a location of the second memory 240 where the result data of the particular operation are stored. The count (COUNT 2) represents a quantity of data to be transferred to the first memory 230 from the second memory 240. The destination address (M1 DEST ADDR 2) points to a location of the first memory 230 where the data of the second memory 240 is to be stored into the second register block 320.

As illustrated in the second portion of FIG. 4, the second processor 220 provides a source address S2 of the second memory 240, a destination address D2 of the first memory 230 and a count (2) COUNT 2 of data to be transferred to the first memory 230 into the controller 330 during a first clock cycle. Data may be read from the second memory 240 by as much as the quantity of the count value, and the read data is provided to the first memory 230 via the third memory 340.

As further illustrated in FIG. 4, the second processor 220 provides a source address S2 of the second memory 240, a destination address D2 of the first memory 230 and a count (1) COUNT 2 of the data to be transferred to the second memory 240 into the controller 330 during a second clock cycle.

The second processor 220 provides a source address S2 of the second memory 240, a destination address D2 of the first memory 230 and a count (0) COUNT 2 of the data to be transferred to the first memory 230 into the controller 330 during a third clock cycle. When the count value is equal to ‘0’, the data transfer operation is completed.

As illustrated by the ‘A’ in FIG. 5, when a process of transferring data read from the first memory 230 to the second memory 240 overlaps a process of transferring data read from the second memory 240 to the first memory 230, the arbiter (included in the controller 330) may appropriately delay an execution point of the second start command START 2 to control the execution points of the process of transferring data read from the first memory 230 to the second memory 240 and the process of transferring data read from the second memory 240 to the first memory 230, so as to avoid overlapping both data transfer processes.

As briefly discussed above with respect to FIGS. 2 through 5, the bridge DMA is configured to control data transfer between the first and second memories. According to some embodiments of the present invention, data transfer speeds of the data transfer systems may be increased using the bridge DMA device for transferring data between a first memory coupled to a first processor and a second memory coupled to a second processor.

In the drawings and specification, there have been disclosed typical preferred embodiments of the invention and, although specific terms are employed, they are used in a generic and descriptive sense only and not for purposes of limitation, the scope of the invention being set forth in the following claims.

That which is claimed is:

1. A data transfer system comprising:
a bridge direct memory access (DMA) device;
a first memory associated with a first processor circuit electrically coupled to the bridge DMA device; and
a second memory associated with a second processor circuit electrically coupled to the bridge DMA device, the bridge DMA device being configured to control data transfer operations directly between the first memory and the second memory.

2. The data transfer system of claim 1, wherein the bridge DMA device comprises:
a first register block configured to store first transfer information for transferring data stored in the first memory to the second memory;
a second register block configured to store second transfer information for transferring data stored in the second memory to the first memory; and
a controller, electrically coupled to the first and second register blocks, configured to control the data transfer operations between the first memory and the second memory responsive to the first transfer information and/or the second transfer information.

3. The data transfer system of claim 2, wherein the bridge DMA device further comprises a third memory configured to store data read from the first memory and/or the second memory based on the first and/or second transfer information responsive to a first control signal of the controller.

4. The data transfer system of claim 3, wherein the bridge DMA device further comprises an address generator configured to generate a first address of the first memory and/or a second address of the second memory to transfer the data stored in the third memory responsive to a second control signal of the controller.

5. The data transfer system of claim 2, wherein the first register block comprises:
a first address register having a source address of the first memory;
a second address register having a destination address of the second memory; and
a first count register having a data quantity to be transferred to the second memory from the first memory.

6. The data transfer system of claim 5, wherein the second register block comprises:
a third address register having a source address of the second memory;
a fourth address register having a destination address of the first memory; and
a second count register having a data quantity to be transferred to the first memory from the second memory.

7. The data transfer system of claim 6:
wherein the first memory is electrically coupled to the first processor and the second memory is electrically coupled to the second processor,
wherein the first processor is configured to generate the source address of the first memory, the destination address of the first memory and the data quantity to be transferred to the second memory from the first memory; and
wherein the second processor is configured to generate the source address of the second memory, the destination address of the second memory and the data quantity to be transferred to the first memory from the second memory.

8. The data transfer system of claim 2, wherein the controller comprises:
a first start register configured to receive a first start command instructing an execution point of transferring data from the first memory to the second memory; and
a second start register configured to receive a second start command instructing an execution point of transferring data from the second memory to the first memory.

9. The data transfer system of claim 8, wherein the controller further comprises an arbiter configured to delay an execution point of the second start command for a predetermined period of time so as to avoid overlapping between a process transferring data from the first memory to the second memory and a process transferring data from the second memory to the first memory.

10. A bridge DMA device configured to control data transfer operations between a first memory electrically coupled to the bridge DMA device and a second memory electrically coupled to the bridge DMA device, the bridge DMA device comprising:
a first register block configured to store first transfer information for transferring data stored in the first memory to the second memory;
a second register block configured to store second transfer information for transferring data stored in the second memory to the first memory; and
a controller, electrically coupled to the first and second register blocks, configured to control the data transfer operations directly between the first memory and the second memory responsive to the first transfer information and/or the second transfer information.

11. The bridge DMA device of claim 10, further comprising a third memory configured to store data read from the first memory and/or the second memory based on the first and/or second transfer information responsive to a first control signal of the controller.

12. The bridge DMA device of claim 11, further comprising an address generator configured to generate a first address of the first memory and/or a second address of the second memory to transfer the data stored in the third memory responsive to a second control signal of the controller.

13. The bridge DMA device of claim 10, wherein the first register block comprises:
a first address register having a source address of the first memory;
a second address register having a destination address of the second memory; and
a first count register having a data quantity to be transferred to the second memory from the first memory.

14. The bridge DMA device of claim 13, wherein the second register block comprises:
a third address register having a source address of the second memory;
a fourth address register having a destination address of the first memory; and
a second count register having a data quantity to be transferred to the first memory from the second memory.

15. The bridge DMA device of claim 14:
wherein the first memory is electrically coupled to a first processor and the second memory is electrically coupled to a second processor,
wherein the first processor is configured to generate the source address of the first memory, the destination address of the first memory and the data quantity to be transferred to the second memory from the first memory; and
wherein the second processor is configured to generate the source address of the second memory, the destination address of the second memory and the data quantity to be transferred to the first memory from the second memory.

16. The bridge DMA device of claim 10, wherein the controller comprises:
a first start register configured to receive a first start command instructing an execution point of transferring data from the first memory to the second memory; and
a second start register configured to receive a second start command instructing an execution point of transferring data from the second memory to the first memory.

17. The bridge DMA device of claim 16, wherein the controller further comprises an arbiter configured to delay an execution point of the second start command for a predetermined period of time so as to avoid overlapping between a process transferring data from the first memory to the second memory and a process transferring data from the second memory to the first memory.

18. A method of operating a data transfer system comprising transferring data between a first memory electrically coupled to a bridge direct memory access (DMA) device and a second memory electrically coupled to the bridge DMA device, the bridge DMA device being configured to control the transfer of data between the first memory and the second memory.

19. A method of performing a data transfer operation using a bridge direct memory access (DMA) device between a first memory coupled to a first processor and a second memory coupled to a second processor, the method comprising:
generating first transfer information for transferring data stored in the first memory directly to the second memory;
transferring the data stored in the first memory to the second memory responsive to the first transfer information;
performing an operation at the second processor using data stored in the second memory;
storing result data of the operation in the second memory;
receiving second transfer information for transferring the result data of the operation stored in the second memory to the first memory; and
transferring the result data of the operation to the first memory responsive to the second transfer information.

20. The method of claim 19, wherein the first transfer information comprises:
a source address of the first memory;
a destination address of the second memory; and
a data quantity to be transferred to the second memory from the first memory.

21. The method of claim 20, wherein the second transfer information comprises:
a source address of the second memory;
a destination address of the first memory; and
a data quantity to be transferred to the first memory from the second memory.

22. The method of claim 21:
wherein generating the first transfer information comprises generating the source address of the first memory, the destination address of the first memory and the data quantity to be transferred to the second memory from the first memory at the first processor; and
wherein generating the second transfer information comprises generating the source address of the second memory, the destination address of the second memory and the data quantity to be transferred to the first memory from the second memory at the second processor.

23. A method of performing a data transfer operation using a bridge direct memory access (DMA) device between a first memory electrically coupled to a first processor and a second memory electrically coupled to a second processor, the method comprising:
generating first transfer information for transferring data stored in the first memory to the second memory;
storing data read from the first memory in a third memory;
transferring data stored in the third memory to the second memory responsive to the first transfer information;
generating second transfer information for transferring data stored in the second memory to the first memory;
storing data read from the second memory in the third memory; and
transferring data stored in the third memory to the first memory responsive to the second transfer information.
